(19) United States
(12) Patent Application Publication
(10) Pub. No.: US 2009/0051294 A1
(43) Pub. Date: Feb. 26, 2009

(54) DOOR ENTRY LIGHTING SYSTEM AND INTERIOR WELCOME LIGHTING SYSTEMS WITH AN ADDITIONAL SIGNAL FUNCTION

(76) Inventors: Stefan Moning, Schwelm (DE); Dirk Wittwer, Heiligenhaus (DE); Helmut Schumacher, Coesfeld (DE)

Correspondence Address: Fay Sharpe LLP, 1228 Euclid Avenue, 5th Floor, The Halle Building, Cleveland, OH, 44115-1843, US

(21) Appl. No.: 12/192,483

(22) Filed: Aug. 15, 2008

(30) Foreign Application Priority Data
Aug. 22, 2007 (DE) 10 2007 039 677.7

(51) Int. Cl. B60Q 1/14

(52) U.S. Cl. 315/77

(57) ABSTRACT

A door entry or interior Welcome lighting system for a motor vehicle includes a lamp and a control circuit. The lamp has at least one RGB-LED component with an LED shining red, an LED shining green, an LED shining blue and connecting lines for separately controlling the three LEDs. The control circuit is coupled to the connecting lines and receives control signals on control lines which indicate on the one hand the requirement for switching on the illumination and, on the other hand, at least one operational condition of a closure device of the motor vehicle. On receipt of the control signals indicating the requirement for switching-on the illumination, the control circuit controls the three LEDs, in a first control mode so that a continuous, white to yellow-white illumination of the door entry area or the motor vehicle interior is produced. In a second control mode, the control circuit controls the three LEDs, in dependence on the control signals indicating an operational state of the closure device, so that a coloured illumination is produced. The additional signal function enables the closure state of the closing device to be indicated to a user in a simple manner.

### FIELD OF THE INVENTION

The invention relates to an entry lighting system or a “Welcome” interior lighting system in a motor vehicle. An entry lighting system is a lamp, which is mounted in the vicinity of a motor vehicle door (for instance the driver door or tailgate) and which is conventionally switched on when the driver approaches or after actuation of an electronic key and subsequent access authorisation and illuminates a region of the ground in front of the door or tailgate. Such an entry lighting system can be mounted, for instance, on the underside of the rear view mirror or directly on the door handle. A Welcome lighting system is a light in the interior of the vehicle, which is switched on e.g. when access authorisation has been determined. This lighting system is mounted, for instance, in the vicinity of the interior rear view mirror.

### DESCRIPTION OF THE PRIOR ART

The aforementioned lights are commonly operated with an incandescent lamp. If an entry lighting system is to be arranged in a door handle at a position at which the accommodation of an incandescent lamp is difficult, the incandescent lamp is mounted at a different position in known arrangements and a light guide extends to the radiant location. A light module is also disclosed in U.S. Pat. No. 6,152,590, in which a plurality of white light diodes are used.

It is the object of the invention to provide an energy-saving lighting system of a type referred to above, which can be equipped with an additional signal function.

### SUMMARY OF THE INVENTION

This object is solved in accordance with the invention with a door entry or interior Welcome lighting system with the features of claim 1. In accordance with the invention, the door entry or interior Welcome lighting system for a motor vehicle includes a lamp and a control circuit. The lamp has at least one RGB-LED component (LED=Light Emitting Diode) with an LED shining red, an LED shining green, an LED shining blue and connecting lines for separately controlling the three LEDs. A commercially available RGB-LED component with six connections, i.e. two for each of the three integrated LEDs, or a component with for connections, in which the three LEDs have a common connection, can be used. The control circuit is coupled to the connecting lines and receives control signals which indicate on one hand the requirement for switching-on the illumination and, on the other hand, at least one operational state of a closure device of the motor vehicle. The control signals indicating the requirement for switching-on the illumination correspond functionally to the normal switching-on signal of the conventional lighting system. On receipt of the control signals indicating the requirement for switching on the illumination, the control circuit controls the three LEDs, in a first control mode, so that a continuous white to yellow-white illumination of the door entry area or the motor vehicle interior is produced. In a second control mode, the control circuit controls the three LEDs, in dependence on control signals indicating an operational state of a closing device, so that a coloured illumination is produced. The use of the RGB-LED component permits not only an energy-saving white or yellow-white illumination of the area or interior. It also permits a coloured illumination with an associated signal function. Furthermore, a desired hue of the white illumination can also be set. The additional signal function enables the closing state of the closure device to be indicated to a user in a simple manner.

The control signals can be supplied on separate lines of the control circuit or can also be serially coded on one line. The control signals indicating the requirement for switching-on the illumination could indicate not only the moment of switching-on but also the duration of the switch-on period. In a preferred embodiment, however, the control signals include a switching-on signal and at least one control signal, which indicates at least one operational state of a closure device of the motor vehicle. The switching-on signal is to be understood in this case as a signal which indicates directly whether the door entry area or interior Welcome lighting system is to be switched on or not. This switching-on signal corresponds to the switching-on signal in the conventional lighting system. The operational state of the closure device can be indicated by a binary control signal, which indicates, in one state, the release of the door closure device and, in another state, the locking thereof. A plurality of control signals can also indicate further operational states of the closure device. In addition to the locking or unlocking (release) of the door closure device, the indicated operational states can also include the detected approach of a user, the result of the check on the access authorisation or the fact that a door is open.

In a preferred embodiment of the invention, the control circuit receives the switching-on signal from a control device when the control device detects the approach of a driver and/or an access authorisation. The switching-on signal is commonly only applied not every time a person approaches but only when, after the detection of the approach of a person, their access authorisation is detected. In one embodiment, the switching-on signal can be applied to the control circuit by the control device for a predetermined period of time (in which the illumination is to be switched on). In an alternative embodiment, the control circuit controls the three LEDs in a first control mode, after receiving the switching-on signal, for a predetermined period of time. In this case the control circuit determines the duration of switching-on.

A preferred embodiment of the invention is characterised in that the control circuit so controls the three LEDs, in the second control mode, that a flashing illumination is produced. The control circuit preferably controls (a) the three LEDs, on receipt of a control signal indicating a locked state of the closing device, so that a red illumination is produced and (b) on receipt of a control signal indicating a locked stated of the closing device, so that a green illumination is produced.

With regard to the sequence of switching on the normal (white) illumination and the (for instance red or green flashing) signal illumination, a series of embodiments are possible. The sequences depend on whether the area or interior illumination is activated when a driver gets in or after he gets out. In one embodiment, the control circuit receives the control signals, which indicate the operational state of the closure device, from the control device, whereby the control device applies these control signals and the switching-on signal in a predetermined order (sequence). It is preferred that after the detection of the approach of the driver when the closing device is locked and subsequent unlocking of the closure device, the control device firstly produces the control signal indicating the operational state of the closure device and subsequently the switching-on signal.

Advantageous and/or preferred embodiments of the convention are characterised in the dependent claims.

The invention will be explained in more detail below with reference to a preferred exemplary embodiment, which is illustrated in the drawing.

### BRIEF DESCRIPTION OF THE DRAWING

FIG. 1 is a block circuit diagram of a door entry lighting system in accordance with the invention, which is coupled to a control device.

### DESCRIPTION OF THE PREFERRED EMBODIMENT

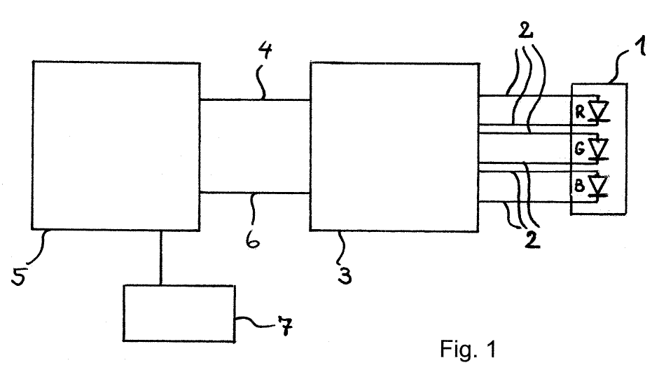

FIG. 1 is a block circuit diagram of a door entry lighting system in accordance with invention. The door entry lighting system includes an RGB-LED component 1, which is coupled to a control circuit 3 by connecting lines 2. The RGB-LED component (RGB=Red/Green/Blue; LED=Light Emitting Diode) has a red emitting LED (R) and a green emitting LED (R), a blue emitting LED (R). In the exemplary embodiment illustrated in FIG. 1, two respective separate connecting lines 2 extend from each of the three LEDs to the control circuit 3. Embodiments are also possible in which the three LEDs use a common connecting line so that four connecting lines in total are necessary. The control circuit 3 is coupled to a voltage supply (not shown) and includes driver circuits for the LEDs and a control logic system. An input connection of the control circuit 3 receives a switch-on signal on line 4 from a control device 5. The switch-on signal on line 4 indicates in this embodiment that the door entry lighting system (normal) is to be switched on. When the switch-on signal is applied to line 4, the control circuit 3 controls the three LEDs, in a first control mode (normal control mode), so that a continuous white to yellow-white illumination of the door entry area is produced. Continuous illumination is to be understood in this case as control of the LEDs which appears to the driver to be continuous. The intensity of illumination need not be constant; it can also gradually increase or decrease. The term is, however, not to include any perceptible flashing or flickering. The illumination does not need to be pure white; a colouration is also possible.

The control circuit 3 is coupled to the control device 5 via least one further signal line 6. On this at least one signal line 6, the control device 5 supplies to the control circuit 3 at least one control signal, which indicates at least one operational state of a closure device of the motor vehicle. For this purpose, the control device 5 is coupled to the closure device 7. This coupling can be by way of wires or wireless. The control circuit 3 controls the three LEDs in a second control mode in dependence on the control signal on line 6, which indicates an operational state of the closure device, such that a coloured illumination is produced. When a signal is present on line 6, which indicates that the door closure device has been released, the green LED is preferably controlled in the second control mode so as to flash. When there is a control signal on line 6 which indicates that the door closure device is locked, the control circuit 3 controls the red LED in the second operational mode so as to flash.

The sequence in which the normal white illumination and the flashing red or green illumination are controlled is predetermined either by the control device 5 with the aid of the predetermined sequence of the control signals supplied to the lines 4 and 6 or the by control circuit 3 in dependence on the control signals previously applied to the lines 4 and 6. For instance, if there is simultaneous application of the switching-on signal to line 4 and a control signal indicating the locked state on line 6, the control circuit 3 could firstly control flashing of the red or green LED for predetermined period of time and then a white entry illumination. The driver wishing to gain access to the motor vehicle would then detect from the flashing preceding the normal entry illumination whether the door handle is unlocked or not before actuating the door handle. The signal illumination could furthermore be activated also when the driver gets out and locks the motor vehicle, whereby in this case a reverse sequence or omission of the entry lighting in the sequence are possible.

The RGB-LEDs can be mounted, with or without the control circuit 3, for instance in the cap for the closure cylinder, in the door handle, on the recessed handle moulding or on the tailgate light unit. The control circuit can include a microcontroller, depending on which part of the control logic system is to be accommodated in the control circuit 3 and which part of it needs to be accommodated in the control device. The control circuit 3 or the control device 5 are coupled to the vehicle bus in order to pick up the necessary control signals from it.

1. A door entry interior Welcome lighting system for a motor vehicle with a lamp and a control circuit,
wherein the lamp includes at least one RGB-LED Component with an LED shining red, an LED shining green, an LED shining blue and connecting lines for separately controlling the three LEDs,
wherein the control circuit is coupled to the connecting lines and receives control signals, which indicate on the one hand the requirement for switching on the illumination and on the other hand at least one operational state of a closure device of the motor vehicle,
wherein, on receipt of the control signals indicating the requirement of switching on the illumination, the control circuit controls the three LEDs in a first control mode that a continuous, white to yellow-white illumination of the door entry area or the motor vehicle interior is produced and
wherein the control circuit so controls the three LEDs in dependence on the control signals indicating an operational state of a closure device in a second control mode that a coloured illumination is produced.

2. A door entry or interior Welcome lighting system for motor vehicle as claimed in claim 1, characterised in that the control signals include a switching-on signal and at least one control signal, which indicates at least one operational state of a closure device of the motor vehicle.

3. A door entry or interior Welcome lighting system for a motor vehicle as claimed in claim 2, characterised in that the at least one control signal indicates release and locking of the door closure device.

4. A door entry or interior Welcome lighting system for a motor vehicle as claimed in claim 2, characterised in that the control circuit receives the switching-on signal from a control device when the control device detects the approach of a driver and/or access authorisation.

5. A door entry or interior Welcome lighting system for a motor vehicle as claimed in claim 4, characterised in that the control circuit receives the switching-on signal for predetermined period of time after the approach of a driver and the access authorisation has been detected.

6. A door entry or interior Welcome lighting system for a motor vehicle as claimed in claim 4, characterised in that, after receipt of the switching-on signal, the control circuit controls the three LEDs in the first control mode for a predetermined period of time.

7. A door entry or interior Welcome lighting system for a motor vehicle as claimed in claim 4, characterised in that the control circuit so controls the three LEDs in the second control mode that a flashing illumination is produced.

8. A door entry or interior Welcome lighting system for a motor vehicle as claimed in claim 4, characterised in that the control circuit (a) so controls the three LEDs, on receipt of a control signal indicating a locked state of the closure device, that a red illumination is produced and (b) so controls the three LEDs, on receipt of a control signal indicating an unlocked state of the closure device, that a green illumination is produced.

9. A door entry or interior Welcome lighting system for a motor vehicle as claimed in claim 4, characterised in that the control circuit receives the control signals indicating the operational state of the closure device from the control device, wherein the control device applies these control signals and a switching-on signal in a predetermined sequence.

10. A door entry or interior Welcome lighting system for a motor vehicle as claimed in claim 9, characterised in that after the detection of the approach of a driver when the closure device is locked and subsequent unlocking of the closure device, the control device firstly outputs the control signal indicating the operational state of the closure device and subsequently the switching-on signal.
